(19) United States
(12) Patent Application Publication
(10) Pub. No.: US 2012/0013288 A1
(43) Pub. Date: Jan. 19, 2012

(54) SOLAR CELL SYSTEM

(75) Inventors: Tae Young KIM, Seoul (KR); In Taek SONG, Gyeonggi-do (KR); Seung Yun OH, Gyeonggi-do (KR); Jin Mun RYU, Gyeonggi-do (KR)

(73) Assignee: Samsung Electro-Mechanics Co., Ltd.

(21) Appl. No.: 13/186,136

(22) Filed: Jul. 19, 2011

(30) Foreign Application Priority Data
Jul. 19, 2010 (KR) 10-2010-0069471

(51) Int. Cl. H02J 7/00

(52) U.S. Cl. 320/101

(57) ABSTRACT

Disclosed herein is a solar cell system. The solar cell system includes: a solar cell module configured of a single cell and converting solar light irradiated to the cell into electric energy; and a controller boosting voltage generated from the cell and storing the boosted voltage in a battery, differently controlling a level obtained by boosting the voltage of the cell according to a storage state of the battery, light quantity of solar light and external temperature, and limiting the boosted level to a voltage level or less corresponding to a maximum output point varied according to the light quantity and the external temperature. The solar cell system can obtain the maximum output regardless of the change in external temperature or light quantity of solar light, thereby making it possible to improve efficiency of the system.

### CROSS REFERENCE TO RELATED APPLICATION

This application claims the benefit of Korean Patent Application No. 10-2010-0069471, filed on Jul. 19, 2010, entitled “Solar Cell System”, which is hereby incorporated by reference in its entirety into this application.

### BACKGROUND OF THE INVENTION

1. Technical Field

The present invention relates to a solar cell system, and more particularly, to a solar cell system capable of implementing a maximum output regardless of a change in light quantity or external temperature.

2. Description of the Related Art

Recently, even though fossil fuels deposits have gradually decreased worldwide, the usage of fossil fuels has further increased. Therefore, alternative energies capable of replacing fossil fuels have been actively developed and the market for alternative energies has remarkably grown. Among alternative energies, a lot of technology for solar energy has been developed and many products capable of being used in real life by converting solar energy into electric energy have been currently available on the market. One of them is a solar cell. The solar cell uses a phenomenon that photoelectro-motive force is generated due to photoelectric effect when solar light is irradiated to a contact surface between a metal and a semiconductor or a PN junction of a semiconductor. The solar cell has gradually become widely used.

Meanwhile, the solar cell includes a module in which several cells to which solar light is irradiated are connected in series or in parallel. However, when a plurality of cells are connected in series or in parallel, process costs and material costs for connecting each cell. When any one of the cells is defective or the efficiency thereof is degraded, the efficiency of the entire module is degraded. In addition, when shading is generated in a specific cell according to an incident angle of the solar light, the efficiency of the entire module is also degraded.

### SUMMARY OF THE INVENTION

An object of the present invention is to provide a unit capable of implementing a maximum output regardless of a change in external temperature or light quantity of solar light, together while being configured of a single cell.

According to an exemplary embodiment of the present invention, there is provided a solar cell system, including: a solar cell module configured of a single cell and converting solar light irradiated to the cell into electric energy; and a controller boosting voltage generated from the cell and storing the boosted voltage in a battery, differently controlling a level obtained by boosting the voltage of the cell according to a storage state of the battery, light quantity of solar light and external temperature, and limiting the boosted level to a voltage level or less corresponding to a maximum output point varied according to the light quantity and the external temperature.

According to another embodiment of the present invention, there is provided a solar cell system, including: a solar cell module configured of a single cell and converting solar light irradiated to the cell into electric energy; a converter boosting voltage of the cell to a boosting level and storing the boosted voltage in a battery; a monitoring unit monitoring the storage state of the battery and transmitting the result thereof; and a maximum output point searching unit controlling the boosted level according to the storage state of the battery, and the change in the light quantity of solar light and the external temperature, and limiting the boosted level to a voltage level or less corresponding to the maximum output point varied according to the light quantity and the external temperature.

### BRIEF DESCRIPTION OF THE DRAWINGS

FIG. 1 is a block diagram showing a configuration of a solar cell system according to an exemplary embodiment of the present invention;

FIG. 2A is a diagram showing a relationship between output and voltage of the solar cell system according to a change in light quantity of the solar light;

FIG. 2B is a diagram showing a relationship between output and voltage of the solar cell system according to a change in external temperature;

FIG. 3 is a diagram showing a relationship between output and voltage in order to explain a method of searching a maximum output point within a target voltage range according to an exemplary embodiment of the present invention; and

FIG. 4 is a flow chart showing the method of searching the maximum output point of FIG. 3.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, when a detailed description of well-known technology relating to the present invention may unnecessarily make unclear the spirit of the present invention, the detailed description thereof will be omitted. Further, the following terminologies are defined in consideration of the functions in the present invention and may be construed in different ways by the intention of users and operators. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

Hereinafter, a solar cell system according to exemplary embodiments of the present invention will be described with reference to the accompanying drawings.

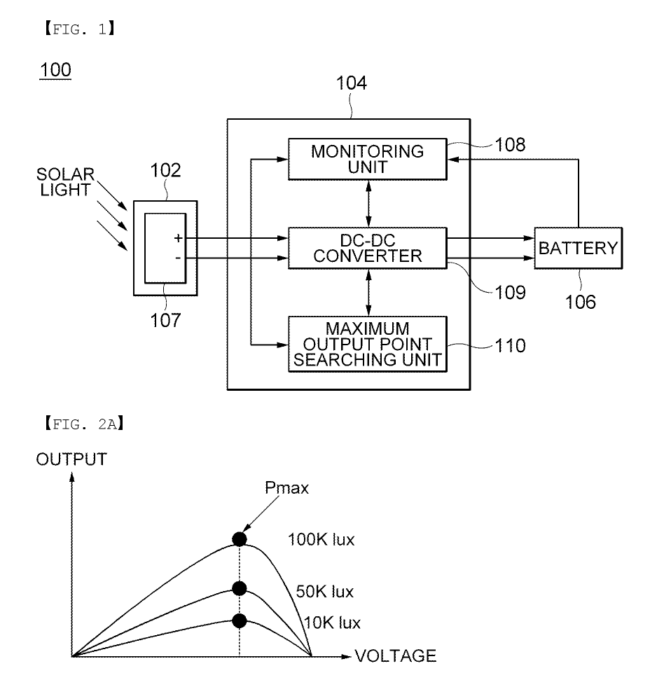

FIG. 1 is a block diagram showing a configuration of a solar cell system 100 according to an exemplary embodiment of the present invention.

The solar cell system 100 according to the exemplary embodiment of the present invention includes a solar cell module 102, a controller 104, and a battery 106.

Functions of each block of the solar cell system 100 constructed as described above will be described.

First, the solar cell module 102 is configured of a single cell 107 to which solar light is directly irradiated. In this case, the cell 107 serves to convert solar energy into electric energy.

The controller 104 receives and boosts voltage generated from the cell 107 to store the boosted voltage in the battery 106. In this case, the controller 104 differently controls a level obtained by boosting the voltage of the cell 107 according to a storage state of the battery 106 and light quantity irradiated to the solar cell system 100 and external temperature. For example, when charges are sufficiently stored in the battery 106, the controller 104 may boost the voltage generated from the cell 107 to a relatively low voltage level.

The controller 104 includes a monitoring unit 108, a DC-DC converter 109, and a maximum output point searching unit 110. Functions of each block will be described.

The monitoring unit 108 monitors the storage state of the battery 106 in real time and transmits the results thereof to the maximum output point searching unit 110.

The maximum output point searching unit 110 searches a maximum output point of the solar cell system 100 to control the operation of the DC-DC converter 109 so that the boosted level does not exceed a voltage level corresponding to the maximum output point. In addition, the maximum output point searching unit 110 also controls the boosted level according to the storage state of the battery 106. In other words, the boosted level may be controlled within a range not exceeding the voltage level corresponding to the maximum output point according to whether charges are sufficiently stored in the battery 106. The maximum output point is varied according to a change in external temperature or light quantity of solar light irradiated and the voltage level corresponding thereto is also varied according to the change in the maximum output point. Therefore, the maximum output point searching unit 110 should control the boosted level in consideration of the light quantity and the external temperature.

Meanwhile, the DC-DC converter 109 boosts the voltage of the cell 107 according to the boosted level controlled by the maximum output point searching unit 110 to store the voltage in the battery 106.

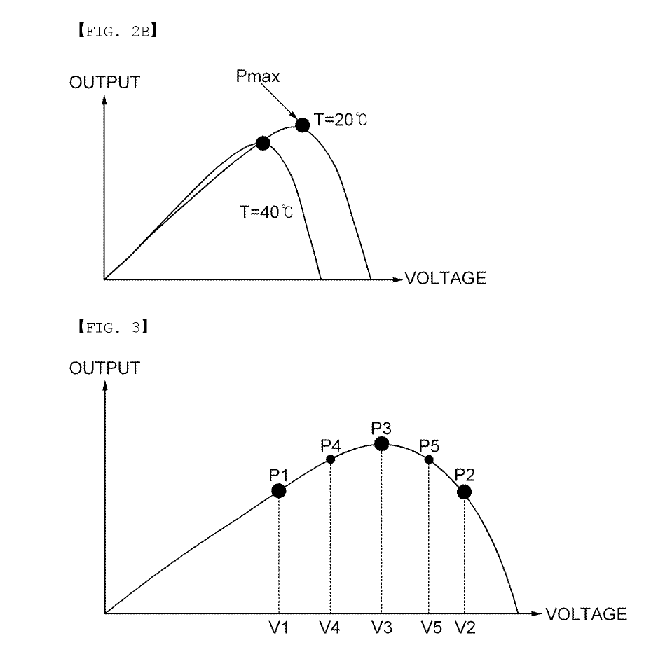

A relationship between the voltage and the output according to the change in the light quantity and the temperature will be described in detail with reference to FIGS. 2A and 2B.

First, referring to FIG. 2A, the voltage level corresponding to the maximum output point Pmax is almost constantly maintained even when there is a change in light quantity irradiated. To the contrary, referring to FIG. 2B, the maximum output point Pmax is relatively significantly changed according to a change in external temperature. For example, as the external temperature is increased, the maximum output point Pmax moves in a direction that voltage is decreased. Therefore, when the voltage generated from the cell 107 is boosted in the DC-Dc converter 109, the voltage level is requested to be controlled in specific consideration to the change in external temperature rather than the change in light quantity. When the boosted level is still maintained as it is even though the external temperature is increased, the maximum output point of the solar cell system 100 is rather decreased.

The maximum output searching unit 110 rapidly searches the maximum output point Pmax varying according to the light quantity and the external temperature, in particular, the external temperature, to limit the boosted level of the DC-DC converter 109 to be within the voltage level corresponding to the maximum output point Pmax. In this case, it is realistically difficult for the maximum output point searching unit 110 to search the maximum output point Pmax throughout the voltage range. Therefore, a predetermined target voltage range is preset in consideration of the output characteristics of the solar cell system 100 and the maximum output point Pmax is searched within the target voltage range, thereby reducing a searching time. The target voltage range may be generally set from a voltage corresponding to the maximum output point at external temperature of 25° C. to a voltage corresponding to 70% of the maximum output point. The target voltage range may also be set again in a region where an average temperature is higher or lower.

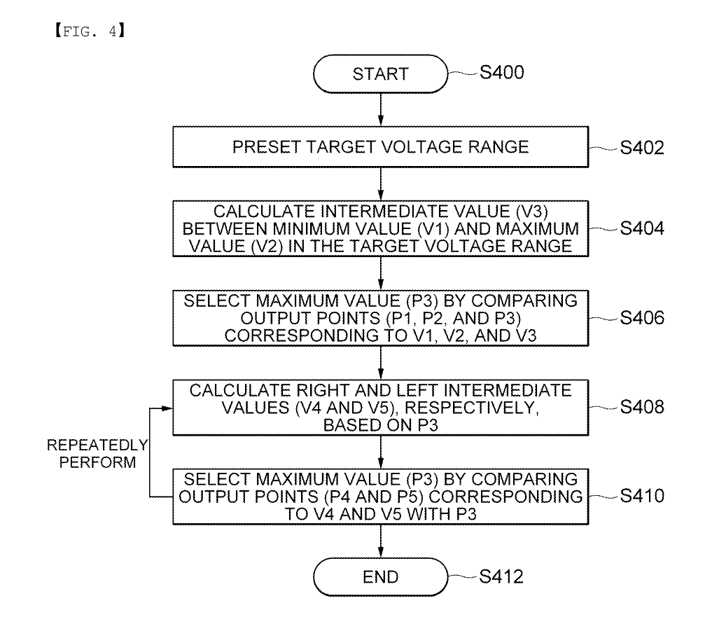

A method of searching the maximum output point Pmax will be described in detail with reference to FIGS. 3 and 4.

First, the target voltage range is preset in consideration of the output characteristics of the solar cell system 100 (S402). In this case, it is assumed that among the voltages within the target voltage range, a minimum value is V1 and a maximum value is V2. Next, an intermediate value V3 is calculated using V1 and V2 (S404). A maximum value P3 is selected by comparing output points P1, P2, and P3 corresponding to V1, V2, and V3 (S406). Next, V4 and V5, that are voltages corresponding to right and left intermediate values based on P3, are calculated (S408). In this case, V4 is equal to (V3-V1)/2 and V5 is equal to (V2-V3)/2. The maximum output point P3 is selected by comparing again the output points P4 and P5 corresponding to V4 and V5 with P3 (S410). In this case, the voltage range from V3 to V5 corresponding to P3 to P5 is a range reduced by ½ as compared to original voltage range from V1 to v2. Thereafter, the searched voltage range is continuously reduced by ½ by repeatedly performing step S408 and step S410, thereby making it possible to search a more accurate maximum output point Pmax.

As described above, the maximum output point searching unit 110 searches the maximum output point Pmax corresponding to the current external temperature, while reducing the preset target voltage range by ½. Therefore, the DC-DC converter 109 boosts the voltage of the cell 107 to the voltage level corresponding to the maximum output point Pmax. In other words, the solar cell system 100 can implement the maximum output regardless of the change in external temperature or light quantity thereof.

According to the present invention, the module is configured of a single cell instead of a plurality of cells connected in parallel or in series, thereby making it possible to reduce manufacturing costs.

In addition, according to the present invention, when voltage generated from the single cell is boosted, the voltage is boosted to voltage corresponding to the maximum output point regardless of the change in light quantity of solar light or external temperature, thereby making it possible to improve efficiency of the system.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. A solar cell system, comprising:
a solar cell module configured of a single cell and converting solar light irradiated to the cell into electric energy; and
a controller boosting voltage generated from the cell and storing the boosted voltage in a battery, differently controlling a level obtained by boosting the voltage of the cell according to a storage state of the battery, light quantity of solar light and external temperature, and limiting the boosted level to a voltage level or less corresponding to a maximum output point varied according to the light quantity and the external temperature.

2. The solar cell system according to claim 1, wherein the controller presets a predetermined target voltage range in consideration of a change in the maximum output point according to a change in the external temperature and the light quantity and searches the maximum output point within the target voltage range.

3. The solar cell system according to claim 1, wherein the controller includes:
a monitoring unit monitoring the storage state of the battery and transmitting the result thereof;
a converter boosting and outputting the voltage of the cell according to the set boosting level; and
a maximum output point searching unit controlling the boosted level according to the storage state of the battery, and the change in the light quantity and the external temperature, and limiting the boosted level to a voltage level or less corresponding to the maximum output point.

4. A solar cell system, comprising:
a solar cell module configured of a single cell and converting solar light irradiated to the cell into electric energy;
a converter boosting voltage of the cell to a boosting level and storing the boosted voltage in a battery;
a monitoring unit monitoring the storage state of the battery and transmitting the result thereof; and
a maximum output point searching unit controlling the boosted level according to the storage state of the battery, and the change in the light quantity of solar light and the external temperature, and limiting the boosted level to a voltage level or less corresponding to the maximum output point varied according to the light quantity and the external temperature.

5. The solar cell system according to claim 4, wherein the maximum output point searching unit presets a predetermined target voltage range in consideration of a change in the maximum output point according to the change in the external temperature and the light quantity and searches the maximum output point within the target voltage range.
